(19) United States
(12) Patent Application Publication
(10) Pub. No.: US 2013/0186992 A1
(43) Pub. Date: Jul. 25, 2013

(54) SORTING MINED MATERIAL

(71) Applicants: Grant Ashley Wellwood, Pheasant Creek (AU); Samuel Kingman, Burton on Trent (GB); Georgios Dimitrakis, Nottingham (GB); Christopher Dodds, Nottingham (GB)

(72) Inventors: Grant Ashley Wellwood, Pheasant Creek (AU); Samuel Kingman, Burton on Trent (GB); Georgios Dimitrakis, Nottingham (GB); Christopher Dodds, Nottingham (GB)

(73) Assignee: TECHNOLOGICAL RESOURCES PTY. LIMITED, Melbourne, Victoria (AU)

(21) Appl. No.: 13/813,599

(22) PCT Filed: Aug. 4, 2011
(86) PCT No.: PCT/AU2011/000986

§ 371 Date: Apr. 11, 2013

(30) Foreign Application Priority Data
Aug. 4, 2010 (AU) 2010903483

(51) Int. Cl. B07C 5/00; B02C 19/18

(52) U.S. Cl. CPC B07C 5/00; B02C 19/18
USPC 241/68; 209/4

(57) ABSTRACT

An apparatus for sorting mined material, such as mined ore, includes an applicator for exposing fragments of a material to electromagnetic radiation and an assembly for distributing fragments from the applicator so that the fragments move downwardly and outwardly from an upper inlet of the assembly and are discharged from a lower outlet of the assembly as individual, separate fragments that are not in contact with each other. The apparatus also includes a detection and assessment system for detecting and assessing one or more than one characteristic of the fragments and a sorting means in the form of a separator for separating the fragments into multiple streams in response to the assessment.

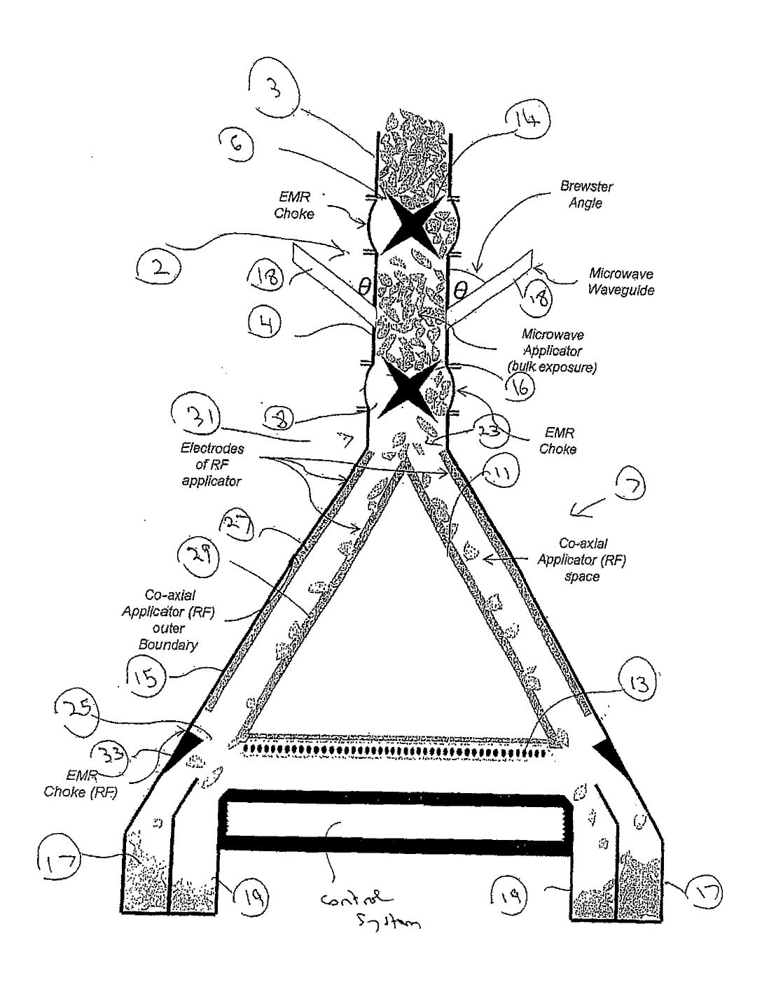

The present invention relates to a method and an apparatus for sorting mined material.

The term “mined” material is understood herein to include metalliferous material and non-metalliferous material. Iron-containing and copper-containing ores are examples of metalliferous material. Coal is an example of a non-metalliferous material. The term “mined” material is understood herein to include, but is not limited to, (a) run-of-mine material and (b) run-of-mine material that has been subjected to at least primary crushing or similar size reduction after the material has been mined and prior to being sorted. The mined material includes mined material that is in stockpiles.

The present invention relates particularly, although by no means exclusively, to a method and an apparatus for sorting mined material for subsequent processing to recover valuable material, such as valuable metals, from the mined material.

The present invention also relates to a method and an apparatus for recovering valuable material, such as valuable metals, from mined material that has been sorted as described above.

The present invention relates to the use of electromagnetic radiation to cause a change in a fragment of a mined material that provides information on characteristics of the mined material in the fragment that is helpful for sorting and/or downstream processing of the fragment and that can be detected by one or more than one sensor. The information may include any one or more of the characteristics of composition, mineralogy, hardness, porosity, structural integrity, and texture.

The present invention relates particularly, although by no means exclusively, to a method and an apparatus for sorting low grade mined material at high throughputs.

The applicant is developing an automated sorting method and apparatus for mined material.

In general terms, the method of sorting mined material being developed by the applicant includes the following steps:

(a) exposing fragments of mined material to electromagnetic radiation,

(b) detecting and assessing fragments on the basis of composition (including grade) or texture or another characteristic of the fragments, and

(c) physically separating fragments based on the assessment in step (b).

Automated ore sorting systems known to the applicant are limited to low throughput systems. The general approach used in these low throughput sorting systems is to convey ore fragments through sorters on a horizontal belt. While horizontal conveyor belts are a proven and effective approach for fragments greater than 10 mm at throughputs up to around 200 t/h, the conveyor belts are unable to cater for the larger throughputs 500-1000 t/h needed to realise the economies of scale required for many applications in the mining industry such as sorting low grade ore having particle sizes greater than 10 mm.

An issue for the technology development path of the applicant relates to detecting mineralisation at low concentrations and in high throughputs. Detection of low concentrations of mineralisation can be addressed by selectively exciting target minerals using electromagnetic radiation. This approach requires the use of an “applicator” which applies the electromagnetic radiation to the fragments in a controlled manner.

The above description is not to be understood as an admission of the common general knowledge in Australia or elsewhere.

In general terms the present invention provides an apparatus for sorting mined material, such as mined ore, that includes an applicator for exposing fragments of a material to electromagnetic radiation, a fragment distribution assembly for distributing fragments from the applicator so that the fragments move downwardly and outwardly from an upper inlet of the assembly and are discharged from a lower outlet of the assembly as individual, separate fragments that are not in contact with each other, a detection and assessment system for detecting and assessing one or more than one characteristic of the fragments, and a sorting means in the form of a separator for separating the fragments into multiple streams in response to the assessment.

According to the present invention there is also provided an apparatus for sorting mined material, such as mined ore, that includes:

(a) an applicator for exposing fragments of a material to electromagnetic radiation, the applicator having an inlet and an outlet,

(b) an assembly for distributing fragments discharged from the electromagnetic radiation applicator so that the fragments are discharged from the assembly as individual, separate fragments that are not in contact with each other, the assembly having an upper inlet and a lower outlet and a downwardly and outwardly extending distribution surface on which fragments are able to move from the upper inlet to the lower outlet and which allows fragments to be distributed into individual, separate fragments by the time the fragments reach the lower outlet;

(c) a detection and assessment system for detecting and assessing one or more than one characteristic of the fragments, and

(d) a sorting means in the form of a separator for separating the fragments into multiple streams in response to the assessment of the detection and assessment system.

The term “fragment” is understood herein to mean any suitable size of mined material having regard to materials handling and processing capabilities of the apparatus used to carry out the method and issues associated with detecting sufficient information to make an accurate assessment of the mined material in the fragment. It is also noted that the term “fragment” as used herein may be understood by some persons skilled in the art to be better described as “particles”. The intention is to use both terms as synonyms.

In use, a feed mined material such as mined ore is supplied to the inlet of the electromagnetic radiation applicator and moves through the applicator to the outlet end of the applicator. The fragments are exposed to electromagnetic radiation in the applicator. Ore from the outlet of the applicator is supplied to the upper inlet of the fragment distribution assembly. The ore moves, for example by sliding and/or tumbling, down the distribution surface of the assembly. The ore moves downwardly and outwardly on the distribution surface from the upper inlet to the lower outlet of the assembly. The distribution surface allows the fragments to disperse into a distributed state in which the fragments are not in contact with other fragments and move as individual, separate fragments and are discharged from the assembly in this distributed state.

The apparatus may include a source of electromagnetic radiation for the electromagnetic radiation applicator.

The electromagnetic radiation applicator may be adapted to expose fragments of mined material to electromagnetic radiation on a fragment by fragment basis.

The electromagnetic radiation applicator may be adapted to expose fragments of mined material to electromagnetic radiation on a bulk basis. This particular combination of the electromagnetic radiation applicator and the fragment distribution assembly, i.e. this particular combination of the electromagnetic radiation applicator adapted to expose fragments of mined material to electromagnetic radiation on a bulk basis and the fragment distribution assembly adapted to distribute the bulk-processed fragments into separate streams of fragments for detection and assessment and then sorting on a fragment-to-fragment basis has advantages in terms of processing material at a high throughput.

The electromagnetic radiation applicator may be adapted for processing material on a bulk basis by being adapted to expose a bed of the material in which the fragments are in contact with each other to electromagnetic radiation. In use of such an arrangement the distribution surface of the downstream fragment distribution assembly allows the fragments to disperse from the bed state to a distributed state in which the fragments are not in contact with other fragments and are discharged from the assembly in this distributed state.

The bed of the material may be a packed bed.

The bed of the material may be a downwardly moving bed.

The bed of the material may be a downwardly moving packed bed.

The electromagnetic radiation applicator may include an open-ended chute. This arrangement is well suited to forming a downwardly moving bed of material, particularly a downwardly moving packed bed of material.

The chute may be arranged vertically or at an angle to the vertical.

The chute may be aligned with the fragment distribution assembly to supply fragments from the chute directly to the assembly.

The electromagnetic radiation applicator may include chokes for preventing electromagnetic radiation escaping from the applicator via the inlet and the outlet.

The choke in the outlet of the electromagnetic radiation applicator may be in the form of a rotary valve, such as a rotatable star wheel, for controlling discharge of material from the applicator.

The electromagnetic radiation applicator may be adapted to operate on a batch basis, with each batch of mined material within the applicator at any point in time being exposed to electromagnetic radiation.

The electromagnetic radiation applicator may be adapted to operate on a continuous basis with mined material moving continuously through the applicator and being exposed to electromagnetic radiation as it moves through the applicator.

The electromagnetic radiation applicator may be adapted to operate with any suitable electromagnetic radiation. For example, the radiation may be X-ray, microwave and radio frequency radiation.

The electromagnetic radiation may be pulsed or continuous electromagnetic radiation.

The selection of exposure parameters, such as the type of radiation and the length of exposure and the energy of the radiation, in the electromagnetic radiation applicator may be based on known information on the mined material and downstream processing options for the mined material.

When the electromagnetic radiation applicator is adapted to operate with microwave radiation, the applicator may include angled waveguides for directing microwave radiation into the applicator.

The waveguides may be located at the Brewster angle in relation to a wall of the electromagnetic radiation applicator.

The term “Brewster angle”, also known as the polarisation angle, is understood herein to mean an angle of incidence at which electromagnetic radiation with a particular polarisation is perfectly transmitted through a surface with no reflection.

By way of further example, when the electromagnetic radiation applicator is adapted to operate with microwave radiation, the applicator may include a ring main positioned around the circumference of the applicator for supplying electromagnetic radiation to the applicator and a series of microwave transparent windows or openings between the applicator and the ring main that allow microwave radiation to be transmitted from the ring main into the applicator.

The distribution surface of the distribution assembly may be a conical surface or a segment of a conical surface that extends downwardly and outwardly.

The distribution surface may be an upper surface of a conical member or a segment of a conical member or an upper surface of a frusto-conical member or a segment of a frusto-conical member that are arranged to extend downwardly and outwardly.

The conical surface may define any suitable cone angle, i.e. any suitable angle to a horizontal axis.

The conical surface may define an angle of at least 30° to a horizontal axis.

The conical surface may define an angle of at least 45° to a horizontal axis.

The conical surface may define an angle of less than 75° to a horizontal axis.

The distribution surface of the distribution assembly may be an upper surface of an angled plate, such as an angled flat plate.

The distribution surface of the distribution assembly may be an upper surface of a pair of plates, such as a pair of flat plates or a pair of curved plates, that extend outwardly and downwardly away from each other.

The distribution assembly may include a chamber that is defined in part by the distribution surface.

The chamber may be a conical or a frusto-conical chamber.

The distribution assembly may be adapted to operate as a second electromagnetic radiation applicator for exposing fragments to electromagnetic radiation as the fragments move down the distribution surface. In that event, the apparatus may include a source of electromagnetic radiation for the chamber. In use of such an arrangement the mined material is exposed to electromagnetic radiation in two applicators, namely this chamber, which is a form of an applicator, and the upstream (in terms of the direction of movement of material) electromagnetic radiation applicator.

The same or different exposure conditions may be used in the two applicators, depending on the requirements in any given situation. For example, the electromagnetic radiation in the electromagnetic radiation applicator may be selected to cause microfracturing of the fragments to break down the fragments into smaller sizes and the electromagnetic radiation in the distribution assembly may be selected to facilitate sorting of the fragments. In this arrangement, the operating conditions in the electromagnetic radiation applicator may be selected, having regard to the characteristics of the mined material so that the fragments fracture to smaller fragments in the electromagnetic radiation applicator and/or as the fragments move through the distribution assembly and/or in downstream processing steps, such as conventional comminution steps. By way of further example, the electromagnetic radiation in one applicator may be selected to allow detection and assessment of one characteristic and the other applicator may be selected to allow detection and assessment of another characteristic of the fragments.

The detection and assessment system may include a sensor for detecting the response, such as the thermal response, of each fragment to electromagnetic radiation.

The detection and assessment system may include a sensor for detecting other characteristics of the fragment. The sensor may include any one or more than one of the following sensors: (i) near-infrared spectroscopy (“NIR”) sensors (for composition), (ii) optical sensors (for size and texture), (iii) acoustic wave sensors (for internal structure for leach and grind dimensions), (iv) laser induced spectroscopy (“LIBS”) sensors (for composition), and (v) magnetic property sensors (for mineralogy and texture); (vi) x-ray sensors for measurement of non-sulphidic mineral and gangue components, such as iron or shale. Each of these sensors is capable of providing information on the properties of the mined material in the fragments, for example as mentioned in the brackets following the names of the sensors.

The detection and assessment system may include a processor for analysing the data for each fragment, for example using an algorithm that takes into account the sensed data, and classifying the fragment for sorting and/or downstream processing of the fragment, such as heap leaching and smelting.

The assessment of the fragments may be on the basis of grade of a valuable metal in the fragments. The assessment of the fragments may be on the basis of another characteristic (which could also be described as a property), such as any one or more of hardness, texture, mineralogy, structural integrity, and porosity of the fragments. In general terms, the purpose of the assessment of the fragments is to facilitate sorting of the fragments and/or downstream processing of the fragments. Depending on the particular circumstances of a mine, particular combinations of properties may be more or less helpful in providing useful information for sorting of the fragments and/or downstream processing of the fragments.

The detection and assessment system may be adapted to generate control signals to selectively activate the separator in response to the fragment assessment.

The lower outlet of the distribution assembly may be adapted to discharge fragments as a downwardly-falling curtain of fragments. The curtain of material is a convenient form for high throughput analysis of fragments.

The separator for separating the fragments into multiple streams in response to the assessment of the detection and assessment system may be any suitable separator. By way of example, the separator may include a plurality of air jets that can be actuated selectively to displace fragments form a path of movement.

The apparatus may be adapted to sort mined material at any suitable throughput. The required throughput in any given situation is dependent on a range of factors including, but not limited to, operating requirements of upstream and downstream operations.

The apparatus may be adapted to sort at least 100 tonnes per hour of mined material.

The apparatus may be adapted to sort at least 500 tonnes per hour of mined material.

The mined material may be any mined material that contains valuable material, such as valuable metals. Examples of valuable materials are valuable metals in minerals such as minerals that comprise metal oxides or metal sulphides. Specific examples of valuable materials that contain metal oxides are iron ores and nickel laterite ores. Specific examples of valuable materials that contain metal sulphides are copper-containing ores. Other examples of valuable materials are salt and coal.

Particular, although not exclusive, areas of interest to the applicant are mined material in the form of (a) ores that include copper-containing minerals such as chalcopyrite, in sulphide forms and (b) iron ore.

The present invention is particularly, although not exclusively, applicable to sorting low grade mined material.

The term “low” grade is understood herein to mean that the economic value of the valuable material, such as a metal, in the mined material is only marginally greater than the costs to mine and recover and transport the valuable material to a customer.

In any given situation, the concentrations that are regarded as “low” grade will depend on the economic value of the valuable material and the mining and other costs to recover the valuable material from the mined material at a particular point in time. The concentration of the valuable material may be relatively high and still be regarded as “low” grade. This is the case with iron ores.

In the case of valuable material in the form of copper sulphide minerals, currently “low” grade ores are run-of-mine ores containing less than 1.0% by weight, typically less than 0.6 wt. %, copper in the ores. Sorting ores having such low concentrations of copper from barren fragments is a challenging task from a technical viewpoint, particularly in situations where there is a need to sort very large amounts of ore, typically at least 10,000 tonnes per hour, and where the barren fragments represent a smaller proportion of the ore than the ore that contains economically recoverable copper.

The term “barren” fragments, when used in the context of copper-containing ores, is understood herein to mean fragments with no copper or very small amounts of copper that can not be recovered economically from the fragments.

The term “barren” fragments when used in a more general sense in the context of valuable materials is understood herein to mean fragments with no valuable material or amounts of valuable material that can not be recovered economically from the fragments.

According to the present invention there is provided a method of sorting mined material, such as mined ore, including the steps of:

(a) exposing fragments of mined material to electromagnetic radiation in an electromagnetic radiation applicator,

(b) supplying the fragments that have been exposed to electromagnetic radiation to a distribution assembly and allowing the fragments to move downwardly and outwardly over a distribution surface of the assembly from an upper inlet to a lower outlet so that the fragments are distributed into individual, separate fragments and are discharged from the assembly as individual, separate fragments;

(c) detecting one or more than one characteristic of the fragments,

(d) assessing the characteristic(s) of the fragments, and

(e) sorting the fragments into multiple streams in response to the assessment of the characteristic(s) of the fragments.

The method may include exposing the fragments to electromagnetic radiation as the fragments move downwardly and outwardly over the distribution surface of the distribution assembly.

Detection step (c) may include detecting the response, such as the thermal response, of each fragment to exposure to electromagnetic radiation.

Assessment step (d) may include analysing the response of each fragment to identify valuable material in the fragment.

Detection step (c) is not confined to sensing the response of fragments of the mined material to electromagnetic radiation and extends to sensing additional characteristics of the fragments. For example, step (c) may also extend to the use of any one or more than one of the following sensors: (i) near-infrared spectroscopy (“NIR”) sensors (for composition), (ii) optical sensors (for size and texture), (iii) acoustic wave sensors (for internal structure for leach and grind dimensions), (iv) laser induced spectroscopy (“LIBS”) sensors (for composition), and (v) magnetic property sensors (for mineralogy and texture); (vi) x-ray sensors for measurement of non-sulphidic mineral and gangue components, such as iron or shale. Each of these sensors is capable of providing information on the properties of the mined material in the fragments, for example as mentioned in the brackets following the names of the sensors.

The method may include a downstream processing step of comminuting the sorted material as a pre-treatment step for a downstream option for recovering the valuable mineral from the mined material.

The method may include a downstream processing step of blending the sorted material as a pre-treatment step for a downstream option for recovering the valuable mineral from the mined material.

The method may include using the sensed data for each fragment as feed-forward information for downstream processing options, such as flotation and comminution, and as feed-back information to upstream mining and processing options.

The upstream mining and processing options may include drill and blast operations, the location of mining operations, and crushing operations.

According to the present invention there is also provided a method for recovering valuable material, such as a valuable metal, from mined material, such as mined ore, that includes sorting mined material according to the method described above and thereafter processing the fragments containing valuable material and recovering valuable material.

The processing options for the sorted fragments may be any suitable options, such as smelting and leaching options.

The present invention is described further by way of example with reference to the accompanying drawing which illustrates diagrammatically a vertical cross-section of one embodiment of key components of a sorting apparatus in accordance with the present invention.

The embodiment is described in the context of the use of microwave energy as the electromagnetic radiation. However, it is noted that the invention is not confined to the use of microwave energy and extends to the use of other types of electromagnetic radiation, such as radio frequency radiation and x-ray radiation.

The embodiment is described in the context of a method and an apparatus for recovering a valuable metal in the form of copper from a low grade copper-containing ore in which the copper is present in copper-containing minerals such as chalcopyrite and the ore also contains non-valuable gangue. The objective of the method in this embodiment is to identify fragments of mined material containing amounts of copper-containing minerals above a certain grade and to sort these fragments from the other fragments and to process the copper-containing fragments as required to recover copper from the fragments.

It is noted that, whilst the following description does not focus on the downstream processing options, these options are any suitable options ranging from smelting to leaching the fragments.

It is also noted that the present invention is not confined to copper-containing ores and to copper as the valuable material to be recovered. In general terms, the present invention provides a method of sorting any minerals which exhibit different heating responses when exposed to electromagnetic radiation.

With reference to the drawing, a feed material in the form of fragments of copper-containing ore that have been crushed by a primary crusher (not shown) to a fragment size of 10-25 cm is supplied via a vertical transfer chute 3 (or other suitable transfer means, such as a conveyor belt supplying material to a feed hopper) to a microwave radiation treatment assembly generally identified by the numeral 2.

The microwave radiation treatment assembly 2 comprises a vertical chute 4 that defines a microwave applicator. The ore is exposed to microwave radiation on a bulk basis as the fragments move downwardly in a bed, preferably a packed bed, through the chute 4 from an upper inlet 6 to a lower outlet 8 of the chute 4. Chokes 14, 16 for preventing microwave radiation escaping from the chute 4 are positioned in the inlet 6 and the outlet 8 of the chute 4. The chokes 14, 16 are in the form of rotary valves in the form of rotatable star wheels in this instance (as shown diagrammatically in the Figure) that control supply and discharge of ore into and from the chute 4.

The microwave radiation treatment assembly 2 also comprises a source of microwave radiation (not shown) and a pair of opposed waveguides 18 for directing microwave radiation into the chute 4. The waveguides 18 are located at the Brewster angle with respect to the wall of the chute 4. It is noted that the waveguides 18 are one of a number of options for introducing microwave radiation into the chute 4. One other, although not the only other, option is to introduce the microwave radiation via a ring main positioned around the circumference of the chute 4, with a series of microwave transparent windows or openings in the chute 4 and the ring main that allow microwave radiation to be transmitted into the chute 4. The size and the number of the openings are selected to provide a homogeneous, i.e. uniform, field in the chute 4.

The outlet 8 of the chute 4 is aligned vertically with an inlet of a fragment distribution assembly. The distribution assembly is generally identified by the numeral 7. The outlet 8 supplies fragments that have been exposed to electromagnetic radiation in the chute 4 directly to the distribution assembly 7.

The distribution assembly 7 includes a distribution surface 11 for the fragments. The fragments move downwardly and outwardly over the distribution surface 11, typically in a sliding and/or a tumbling motion, from an upper central inlet 23 of the distribution assembly 7 to a lower annular outlet 25 of the assembly 7. The distribution surface 11 allows the fragments to disperse from the packed bed state in which the fragments are in contact with each other in the chute 4 to a distributed state in which the fragments are not in contact with other fragments and move as individual, separate fragments and are discharged from the outlet 25 as individual, separate fragments.

The distribution assembly 7 comprises an inner wall having a conical surface that forms the distribution surface 11. The conical surface is an upper surface of a conical-shaped member.

The distribution surface 11 is shrouded by an outer wall having a second concentric outer conical surface 15. The distribution assembly 7 also includes chokes 31, 33 in the upper inlet 23 and the lower outlet 25 of the assembly 7. As a consequence, if required from an operational viewpoint, the assembly 7 may function as a second applicator for further exposing the fragments to electromagnetic radiation. The electromagnetic radiation may be microwave radiation or any other suitable type of radiation. Depending on the circumstances, the apparatus may include another source of electromagnetic radiation in addition to that forming part of the microwave radiation treatment assembly 2. In this context, this configuration of the apparatus has a particular advantage in the case of electromagnetic radiation in the radio frequency band. When operating with radio frequency radiation, the distribution surface 11 and the outer conical surface 15 are electrically isolated and configured to form parallel electrodes of a radio frequency applicator. These electrodes are identified by the numerals 27, 29 in the Figure.

The fragments are detected and assessed by a detection and assessment system as they move through the distribution assembly 7.

More specifically, while passing through the distribution assembly 7, radiation, more particularly heat radiation, from the fragments as a consequence of (a) exposure to microwave energy at the microwave radiation treatment assembly 2 and optionally in the distribution assembly 7 and (b) the characteristics (such as composition and texture) of the fragments is detected by thermal imagers in the form of high resolution, high speed infrared imagers (not shown) which capture thermal images of the fragments. While one thermal imager is sufficient, two or more thermal imagers may be used for full coverage of the fragment surface. It is noted that the present invention is not limited to the use of such high resolution, high speed infrared imagers. It is also noted that the present invention is not limited to detecting the thermal response of fragments to microwave energy and extends to detecting other types of response.

From the number of detected hot spots (pixels), temperature, pattern of their distribution and their cumulative area, relative to the size of the fragments, an estimation of the grade of the fragments can be made. This estimation may be supported and/or more mineral content may be quantified by comparison of the data with previously established relationships between microwave induced thermal properties of specifically graded and sized fragments.

In addition, one or more optical sensors, for example in the form of visible light cameras (not shown) capture visible light images of the fragments to allow determination of fragment size.

The present invention also extends to the use of other sensors for detecting other characteristics of the fragments, such as texture.

Images collected by the thermal imagers and the visible light cameras (and information from other sensors that may be used) are processed in the detection and assessment system by a computer (indicated in the figure by the word “Control System”) equipped with image processing and other relevant software. The software is designed to process the sensed data to assess the fragments for sorting and/or downstream processing options. In any given situation, the software may be designed to weight different data depending on the relative importance of the properties associated with the data. .

The detection and assessment system generates control signals to selectively activate a sorting means in response to the fragment assessment.

More specifically, the fragments free-fall from the outlet 25 of the distribution assembly 7 and are separated into annular collection bins 17, 19 by a sorting means that comprises compressed air jets (or other suitable fluid jets, such as water jets, or any suitable mechanical devices, such as mechanical flippers) that selectively deflect the fragments as the fragments move in a free-fall trajectory from the outlet 25 of the distribution assembly 7. The air jet nozzles are identified by the numeral 13. The air jets selectively deflect the fragments into two circular curtains of fragments that free-fall into the collection bins 17, 19. The thermal analysis identifies the position of each of the fragments and the air jets are activated a pre-set time after a fragment is analysed as a fragment to be deflected.

The positions of the thermal imagers and the other sensors and the computer and the air jets may be selected as required. In this connection, it is acknowledged that the figure is not intended to be other than a general diagram of one embodiment of the invention.

The microwave radiation may be either in the form of continuous or pulsed radiation. The microwave radiation may be applied at an electric field below that which is required to induce micro-fractures in the fragments. In any event, the microwave frequency and microwave intensity and the fragment exposure time and the other operating parameters of the microwave radiation treatment assembly 2 are selected having regard to the information that is required. The required information is information that is required to assess the particular mined material for sorting and/or downstream processing of the fragments. In any given situation, there will be particular combinations of characteristics, such as grade, mineralogy, hardness, texture, structural integrity, and porosity, that will provide the necessary information to make an informed decision about the sorting and/or downstream processing of the fragments, for example, the sorting criteria to suit a particular downstream processing option.

As noted above, there may be a range of other sensors (not shown) other than thermal imagers and visible light cameras mentioned above positioned within and/or downstream of the microwave radiation treatment assembly 2 and the distribution assembly 7 to detect other characteristics of the fragments depending on the required information to classify the fragments for sorting and/or downstream processing options.

In one mode of operation the thermal analysis is based on distinguishing between fragments that are above and below a threshold temperature. The fragments can then be categorised as “hotter” and “colder” fragments. The temperature of a fragment is related to the amount of copper minerals in the fragment. Hence, fragments that have a given size range and are heated under given conditions will have a temperature increase to a temperature above a threshold temperature “x” degrees if the fragments contain at least “y” wt. % copper. The threshold temperature can be selected initially based on economic factors and adjusted as those factors change. Barren fragments will generally not be heated on exposure to radio frequency radiation to temperatures above the threshold temperature.

In the present instance, the primary classification criteria is the grade of the copper in the fragment, with fragments above a threshold grade being separated into collection bin 19 and fragments below the threshold grade being separated into the collection bin 17. The valuable fragments in bin 19 are then processed to recover copper from the fragments. For example, the valuable fragments in the bin 19 are transferred for downstream processing including milling and flotation to form a concentrate and then processing the concentrate to recover copper.

The fragments in collection bin 17 may become a by-product waste stream and are disposed of in a suitable manner. This may not always be the case. The fragments have lower concentrations of copper minerals and may be sufficiently valuable for recovery. In that event the colder fragments may be transferred to a suitable recovery process, such as leaching.

Advantages of the present invention include the following advantages.
Processing ore fragments in bulk form in the microwave radiation treatment assembly 2 has been found to dramatically improve the efficiency of energy delivery compared to a horizontal belt arrangement with a mono-layer of mined material.
Separating bulk processed ore from the microwave radiation treatment assembly 2 into streams of separate fragments of ore in the distribution assembly 7 has advantages in terms of minimising conduction between fragments that could have an impact on the accuracy of fragment analysis.
Fragment orientation changes during downward and outward sliding movement of fragments in the distribution assembly 7 (many ores have orientation specific mineralisation within which can make them impervious to electromagnetic radiation. Belt-based systems are characterised by fixed fragment orientation by fragments sliding down the inner cone will change orientation hence be less susceptible to orientation effects.
Dispersion. Higher solids loadings improve the operation of applicators. However, in conventional belt systems this is compromised by downstream requirements. To minimise separation errors the fragments need to be presented to the detection and separation units in a dispersed manner (typically one fragment diameter separation from an adjacent fragment.) In horizontal belt systems this creates intensity constraints as belt widths and speeds have limitations. In the present invention the fragments sliding and/or tumbling down the distribution surface 11 of the distribution assembly 7 are continually accelerating so it is possible to have a high intensity at the top of the distribution surface 11 (good for electromagnetic radiation exposure) and a dispersed (horizontally by virtue of the increasing diameter of the conical surface and vertically by gravitational acceleration) distribution for the detection and separation stages.
Process intensity (tonnes/h/m² plan area). In order to be viable, high throughput sorting apparatus need high intensity. Unlike belt systems the present invention is capable of higher material throughput as it is unconstrained by mechanical issues like belt speed and loading. Most host sites are constrained by plan area availability hence vertical processing increases viability. The applicator and acceleration, presentation, detection, separation stages can be incorporated into a single device/space.
Mechanically and electromagnetically simpler. The present invention offers fewer moving parts overall and no moving parts in the applicator and simpler electromagnetic and mechanical design,
Economies of scale. The present invention could be scaled easily to very large size to create high capacity modules. Conventional belt based systems have virtually no economy of scale potential and there are practical limits on individual belt width as well.
Flexibility-staged processing. The temperature tag for sorting induced by electromagnetic radiation can be preserved for many seconds. The embodiment of a vertically-orientated concentric conical member is very amenable to stacking (cascade) and, hence, multiple detection separation stages which could employed using a single applicator to minimise sorting errors.
Containment: Dust, noise and electromagnetic radiation containment is made easier by the combination of the chute 4 of the microwave radiation treatment assembly 2 and the co-axial distribution surface 11 of the distribution assembly 7 of the above-described embodiment, where all the activity takes place in cylindrical space of the chute and the annular space of the co-axial distribution assembly. This arrangement is also more conducive to environmental controls identified to enhance the process. Plug flow down the feed tube to the apex of the conical surface of the embodiment would function as an effective active choke in the case of electromagnetic radiation in the microwave frequencies.
Rotation of fragments sliding down the distribution surface 11 of the distribution assembly 7 imparts twisting movement of fragments once the fragments go into free fall after being discharged from the chute 4. As the detection is normally done with the fragments in free-fall, the conical surface approach of the embodiment and the twisting imparted may enhance the quality of this step by presenting more surface area for inspection.

Many modifications may be made to the embodiment of the present invention described above without departing from the spirit and scope of the present invention.

By way of example, whilst the mined material is processed on a bulk basis in the microwave radiation treatment assembly 2, the present invention is not so limited and extends to arrangements in which mined material is processed on a fragment by fragment basis in the microwave radiation treatment assembly 2.

By way of further example, whilst the distribution surface 11 of the distribution 7 of the embodiment is a conical surface, the present invention is not so limited and the distribution surface may be any suitable surface that extends downwardly and outwardly. For example, the distribution surface may be a segment of a cone or a frusto-conical surface or a segment of a frusto-conical surface or one or more than one angled plates.

1. An apparatus for sorting mined material, that includes:
(a) an applicator for exposing fragments of a material to electromagnetic radiation, the applicator having an inlet and an outlet,
(b) an assembly for distributing fragments discharged from the electromagnetic radiation applicator so that the fragments are discharged from the assembly as individual, separate fragments that are not in contact with each other, the assembly having an upper inlet and a lower outlet and a downwardly and outwardly extending distribution surface on which fragments are able to move from the upper inlet to the lower outlet and which allows fragments to be distributed into individual, separate fragments by the time the fragments reach the lower outlet,
(c) a detection and assessment system for detecting and assessing one or more than one characteristic of the fragments, and
(d) a sorting means in the form of a separator for separating the fragments into multiple streams in response to the assessment of the detection system.

2. The apparatus defined in claim 1 wherein the applicator is arranged to expose fragments of mined material to electromagnetic radiation on a fragment by fragment basis

3. The apparatus defined in claim 1 wherein the applicator is arranged to expose fragments of mined material to electromagnetic radiation on a bulk basis.

4. The apparatus defined in claim 3 wherein the applicator is adapted to process material on a bulk basis by being adapted to expose a bed of the material in which the fragments are in contact with each other to electromagnetic radiation.

5. (canceled)

6. The apparatus defined in claim 1 wherein the electromagnetic radiation applicator includes a chute with an inlet in an upper end and an outlet in a lower end of the chute.

7. (canceled)

8. The apparatus defined in claim 1 wherein the inlet and the outlet of the electromagnetic radiation applicator include chokes for preventing electromagnetic radiation escaping from the applicator via the inlet and the outlet.

9. The apparatus defined in claim 8 wherein the choke in the outlet of the electromagnetic radiation applicator is in the form of a rotary valve for controlling discharge of material from the applicator.

10. (canceled)

11. The apparatus defined in claim 1 wherein the electromagnetic radiation applicator is adapted to operate with microwave radiation and includes one or more than one waveguide for directing microwave radiation into the applicator.

12. The apparatus defined in claim 11 wherein the electromagnetic radiation applicator includes a ring main for supplying electromagnetic radiation to the applicator positioned around the circumference of the applicator and a series of openings in the applicator and the ring main to allow microwave radiation from the ring main to be transmitted into the applicator.

13. The apparatus defined in claim 1 wherein the fragment distribution assembly is adapted to operate as a second electromagnetic radiation applicator for exposing fragments to electromagnetic radiation as the fragments move down the distribution surface.

14. (canceled)

15. The apparatus defined in claim 13 wherein the electromagnetic radiation applicator is adapted to operate to cause microfracturing of the fragments to break down the fragments into smaller sizes and the second electromagnetic radiation applicator is adapted to operate to facilitate sorting of the fragments.

16. The apparatus defined in claim 13 wherein the electromagnetic radiation applicator is adapted to facilitate detection and assessment of one characteristic and the second electromagnetic radiation applicator is adapted to allow detection and assessment of another characteristic of the fragments.

17. The apparatus defined in claim 1 wherein the distribution surface of the fragment distribution assembly includes a conical surface or a segment of a conical surface that extends outwardly and downwardly.

18. The apparatus defined in claim 17 wherein the conical surface defines an angle of at least 30° to a horizontal axis.

19. (canceled)

20. (canceled)

21. The apparatus defined in claim 1 wherein the distribution surface of the distribution assembly is an upper surface of an angled plate.

22. The apparatus defined in claim 1 wherein the distribution surface of the distribution assembly is an upper surface of a pair of plates that extend outwardly and downwardly away from each other.

23. (canceled)

24. (canceled)

25. (canceled)

26. (canceled)

27. (canceled)

28. The apparatus defined in claim 1 adapted to discharge the fragments from the lower outlet of the distribution assembly as a downwardly-falling curtain of fragments.

29. (canceled)

30. A method of sorting mined material including the steps of:
(a) exposing fragments of mined material to electromagnetic radiation in an electromagnetic radiation applicator,
(b) supplying the fragments that have been exposed to electromagnetic radiation to a distribution assembly and allowing the fragments to move downwardly and outwardly over a distribution surface of the assembly from an upper inlet to a lower outlet so that the fragments are distributed into individual, separate fragments and are discharged from the assembly as individual, separate fragments;
(c) detecting one or more than one characteristic of the fragments,
(d) assessing the characteristic(s) of the fragments, and
(e) sorting the fragments into multiple streams in response to the assessment of the characteristic(s) of the fragments.

31. The method defined in claim 30 includes exposing the fragments to electromagnetic radiation as the fragments move downwardly and outwardly over the distribution surface of the distribution assembly.

32. (canceled)

33. (canceled)

34. (canceled)

35. An apparatus for sorting mined material that includes:
(a) an applicator for exposing fragments of a material to electromagnetic radiation, the applicator having an upper inlet and an lower outlet,
(b) an assembly for distributing fragments discharged from the electromagnetic radiation applicator so that the fragments are discharged from the assembly as multiple free-falling streams of individual, separate fragments that are not in contact with each other, the assembly having an upper inlet for receiving fragments from the applicator and a lower outlet and a distribution surface on which fragments are able to move from the upper inlet to the lower outlet, with the distribution surface including a conical surface or a segment of a conical surface that extends outwardly and downwardly from the inlet,
(c) a detection and assessment system for detecting and assessing one or more than one characteristic of the fragments, and
(d) a sorting means in the form of a separator for separating the fragments in the multiple free-falling streams of fragments in response to the assessment of the detection system.

36. (canceled)

37. (canceled)
